(19) United States
(12) Patent Application Publication
(10) Pub. No.: US 2024/0179381 A1
(43) Pub. Date: May 30, 2024

(54) INFORMATION PROCESSING DEVICE, GENERATION METHOD, AND PROGRAM

(71) Applicant: SONY GROUP CORPORATION, TOKYO (JP)

(72) Inventor: HIROYOSHI FUJII, TOKYO (JP)

(21) Appl. No.: 18/551,794

(22) PCT Filed: Jan. 24, 2022
(86) PCT No.: PCT/JP2022/002394

§ 371 Date: Sep. 21, 2023

(30) Foreign Application Priority Data
Mar. 30, 2021 (JP) 2021-057336

(51) Int. Cl. H04N 21/845; G11B 27/031

(52) U.S. Cl. CPC H04N 21/8456; G11B 27/031

(57) ABSTRACT

The present technique relates to an information processing device, a generation method, and a program that can edit or reproduce a video in a proper form. The information processing device of the present technique includes a generation unit configured to generate reproduction assisting information for reproducing a video of contents and a sound related to the contents, the video and sound included in a target clip among a plurality of clips obtained by dividing data including the video and the sound, the reproduction assisting information generated according to a first degree of importance that is a degree of importance of a plurality of sections obtained by further dividing the video included in the target clip and a second degree of importance that is a degree of importance of a plurality of sections obtained by further dividing the sound included in the target clip. The present technique is applicable to, for example, a lecture capture system used for video-shooting a lecture.

### TECHNICAL FIELD

The present technique relates to an information processing device, a generation method, and a program, and particularly relates to an information processing device, a generation method, and a program that can edit or reproduce a video in a proper form.

### BACKGROUND ART

In the field of education, lectures have been more frequently recorded in recent years. When lectures are recorded as videos, efficient video recording of lectures is required, which includes edits such as deletion of insignificant sections.

For example, PTL 1 describes a technique of editing insignificant sections by evaluating the degree of importance on the basis of the number of utterances, the number of participants in discussion, a discussion time, a volume level, gestures, and emotions or the like in each section of a video that is divided on the basis of the speaking times of persons.

### CITATION LIST

### Patent Literature

[PTL 1]
JP 2016-46705A

### SUMMARY

### Technical Problem

In the technique described in PTL 1, editing is performed while a video signal and a sound signal are synchronized with each other. If editing can be performed without synchronization between the video signal and the sound signal, insignificant video and sound signals are deleted, achieving more efficient video recording.

However, if a video signal and a sound signal are deleted from a long recorded lecture of, for example, 90 minutes according to the degrees of importance, the contents of the video signal and the contents of the sound signal may fail to be consistent with each other, so that the value of the recorded lecture may be lessened as follows:
1. If the video signal is deleted only according to the degree of importance and the sound signal is deleted only according to the degree of importance, a disparity between the contents of the video signal and the contents of the sound signal may increase at a time in the latter half of the recorded lecture. Thus, the recorded lecture may end in failure.
2. If the video signal and the sound signal are each deleted by the same time period according to the degrees of importance, a disparity between the contents of the video signal and the contents of the sound signal may increase at a time around the midpoint of the recorded lecture. Thus, the recorded lecture may end in failure.

The present technique is devised in view of such circumstances and is configured to edit and reproduce a video in a proper form.

### Solution to Problem

An information processing device according to one aspect of the present technique includes a generation unit configured to generate reproduction assisting information for reproducing a video of contents and a sound related to the contents, the video and sound included in a target clip among a plurality of clips obtained by dividing data including the video and the sound, the reproduction assisting information generated according to a first degree of importance that is a degree of importance of a plurality of sections obtained by further dividing the video included in the target clip and a second degree of importance that is a degree of importance of a plurality of sections obtained by further dividing the sound included in the target clip.

According to one aspect of the present technique includes generating reproduction assisting information for reproducing a video of contents and a sound related to the contents, the video and sound included in a target clip among a plurality of clips obtained by dividing data including the video and the sound, the reproduction assisting information generated according to a first degree of importance that is a degree of importance of a plurality of sections obtained by further dividing the video included in the target clip and a second degree of importance that is a degree of importance of a plurality of sections obtained by further dividing the sound included in the target clip.

### BRIEF DESCRIPTION OF DRAWINGS

FIG. 1 illustrates an appearance of a video shooting system according to an embodiment of the present technology.

FIG. 2 is a block diagram illustrating a configuration example of the video shooting system.

FIG. 3 is a block diagram showing a functional configuration example of an arithmetic unit.

FIG. 4 shows an example of an importance determination rule.

FIG. 5 shows an example of a pin detection rule.

FIG. 6 shows an example of an edit rule.

FIG. 7 shows an example of a degree of importance.

FIG. 8 shows an example of pins.

FIG. 9 illustrates an example of a timeline of a lecture video.

FIG. 10 illustrates an example of a timeline of a lecture video.

FIG. 11 illustrates an example of a timeline of a lecture video.

FIG. 12 shows an example of the degrees of importance of determination sections for analysis information.

FIG. 13 illustrates an example of a timeline of recorded data after an edit.

FIG. 14 is a flowchart for explaining processing performed by the arithmetic unit.

FIG. 15 is a block diagram illustrating a configuration example of computer hardware.

### DESCRIPTION OF EMBODIMENTS

An embodiment for implementing the present technique will be described below. The description will be made in the following order.
1. Configuration of Video Shooting System According to Embodiment of Present Technique
2. Example of Edit to Recorded Data
3. Operation of Arithmetic Unit
4. Modification Example

### 1. Configuration of Video Shooting System According to Embodiment of Present Technique

### Configuration Example of Video Shooting System

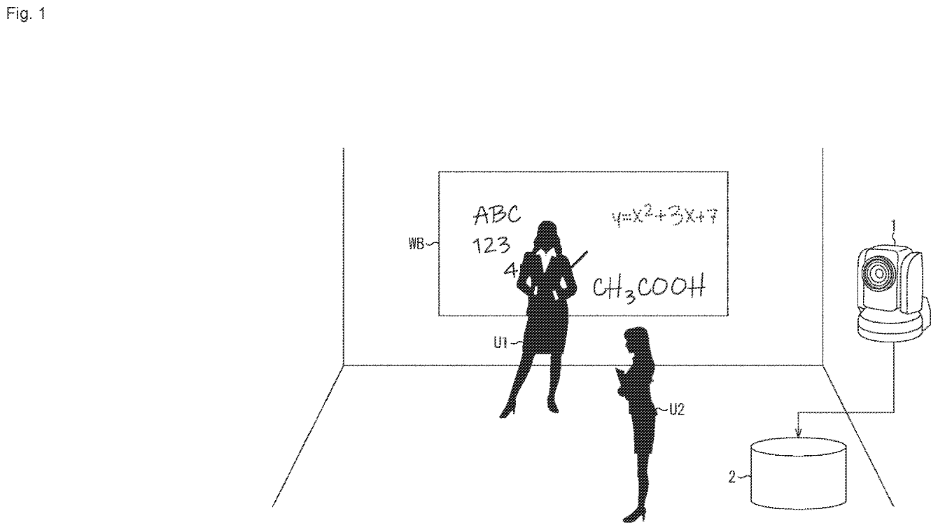

FIG. 1 illustrates an example of a classroom in which a video shooting system according to an embodiment of the present technique is installed.

The video shooting system is configured as a lecture capture system installed in a classroom or an action or the like. FIG. 1 illustrates a state in which a student (auditor) U2 listens to a lecture provided by a teacher (lecturer) U1 with a whiteboard WB in a classroom (lecture room).

The teacher U1 is a person who provides a lecture. The teacher U1 explains the lecture while writing on the whiteboard WB during the lecture.

On the whiteboard WB, writings are added or erased according to the explanation of the lecture. Writings are not limited to a single color, and a plurality of colors may be used. In FIG. 1, characters in solid lines on the whiteboard WB represent characters written with a black pen, whereas characters in dotted lines represent characters written with a red pen.

The student U2 is a person who listens to the lecture. The student U2 makes a comment or moves ahead to write on the whiteboard WB during the lecture. The lecture may be video-shot at sites such as a special studio where the student U2 is not present. Alternatively, the lecture may be video-shot while a plurality of students listen to the lecture in a classroom.

A video shooting device 1 is installed in a lecture room and performs video shooting with an angle of view that includes the teacher U1 and the whiteboard WB. Recorded data including a video signal and a sound signal that are obtained by video recording is outputted to an arithmetic unit 2.

The arithmetic unit 2 receives the recorded data supplied from the video shooting device 1 and determines the degree of importance on the basis of each of the video signal and the sound signal. The arithmetic unit 2 detects a pin from the recorded data and edits the recorded data on the basis of the determination result of the degree of importance and the detection result of the pin. From among a plurality of sections obtained by dividing the recorded data, the pin indicates a section where the timing for reproducing the video signal and the timing for reproducing the sound signal are to be synchronized with each other.

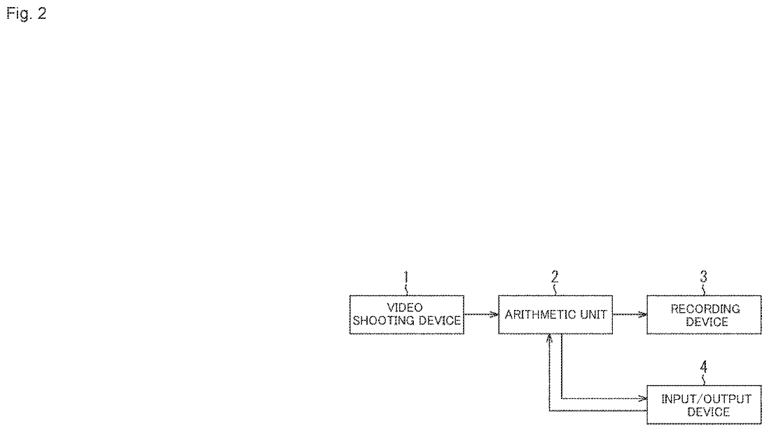

FIG. 2 is a block diagram illustrating a configuration example of the video shooting system.

The video shooting system of FIG. 2 includes the video shooting device 1, the arithmetic unit 2, a recording device 3, and an input/output device 4.

The video shooting device 1 is configured as, for example, a camera for video shooting with an angle of view that includes the teacher U1 and the whiteboard WB at the same time. Recorded data obtained by video recording is outputted to the arithmetic unit 2. The number of video shooting devices 1 is not limited to one and may be two or more.

The arithmetic unit 2 is configured as an information processing device that receives the recorded data supplied from the video shooting device 1 and determines the degree of importance on the basis of each of the video signal and the sound signal. The arithmetic unit 2 is connected to the video shooting device 1 via wire or radio communications.

The arithmetic unit 2 detects a pin from the recorded data and divides the recorded data into clips. The clip is recorded data between the pin and another pin. The arithmetic unit 2 edits the recorded data in clips on the basis of the determination result of the degree of importance and outputs the recorded data to the recording device 3 and the input/output device 4 after the edit.

The arithmetic unit 2 may be configured with dedicated hardware having functions or an ordinary computer with functions implemented by software. The arithmetic unit 2 and the video shooting device 1 may be configured as a single unit instead of independent units.

The recording device 3 records the recorded data that is supplied from the arithmetic unit 2. The recording device 3 and the arithmetic unit 2 may be configured as a single unit instead of independent units. The recording device 3 may be connected to the arithmetic unit 2 via a network.

The input/output device 4 is configured with, for example, a keyboard or a mouse that receives a user operation, a display having a display function, and speakers having a sound output function. The display having the display function may be provided with a touch-panel function.

The input/output device 4 receives an instruction corresponding to a user operation and outputs a rule signal indicating the user instruction to the arithmetic unit 2. For example, a user indicates an importance determination rule about information for determining a degree of importance, a pin detection rule about information for detecting a pin for division into clips, and an edit rule about an edit to be performed on the basis of the determination result of the degree of importance.

The input/output device 4 presents, to the user, video obtained by reproducing the recorded data that is supplied from the arithmetic unit 2.

The input/output device 4 and the arithmetic unit 2 may be configured as a single unit instead of independent units. The input/output device 4 may be connected to the arithmetic unit 2 via a network.

### Functional Configuration Example of Arithmetic Unit 2

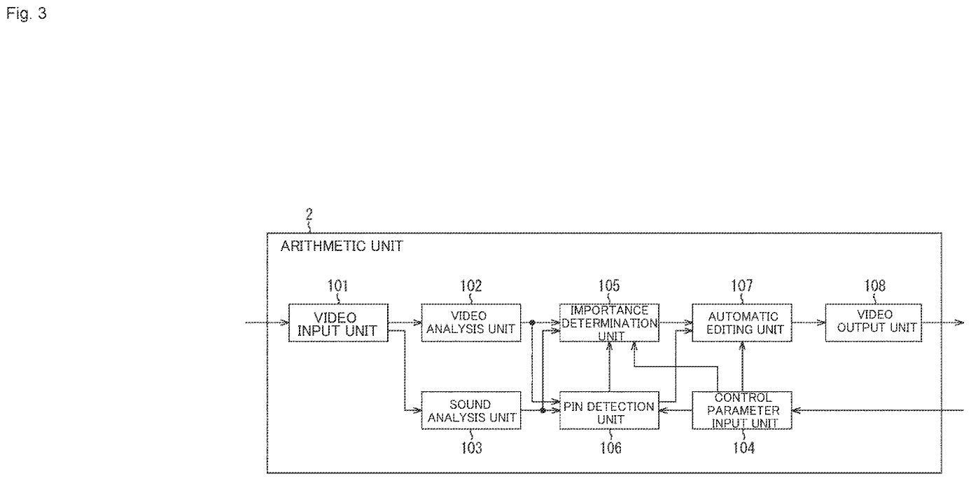

FIG. 3 is a block diagram showing a functional configuration example of the arithmetic unit 2.

The arithmetic unit 2 in FIG. 3 includes a video input unit 101, a video analysis unit 102, a sound analysis unit 103, a control parameter input unit 104, an importance determination unit 105, a pin detection unit 106, an automatic editing unit 107, and a video output unit 108.

The video input unit 101 receives at least one piece of recorded data that is supplied from the video shooting device 1. The recorded data includes a video signal and a sound signal as described above. The video input unit 101 outputs the video signal, which indicates video captured by the video shooting device 1, to the video analysis unit 102 and outputs the sound signal, which indicates a sound collected in a lecture room, to the sound analysis unit 103.

The video analysis unit 102 analyzes video information about at least one kind of lectures on the basis of the video signal supplied from the video input unit 101.

For example, information including the actions of a teacher, the actions of students, the contents of writing on the board, an increase/decrease in the number of characters on the board, the colors of characters on the board, and materials attached to the whiteboard is analyzed by the video analysis unit 102 as video information about a lecture.

The video analysis unit 102 outputs the video information obtained by analysis to the importance determination unit 105 and the pin detection unit 106 along with the video signal.

The sound analysis unit 103 analyzes sound information about at least one kind of lectures on the basis of the sound signal supplied from the video input unit 101.

For example, information including the voices of a teacher, the voices of students, and the sound of a chime is analyzed by the sound analysis unit 103 as sound information about a lecture. Hereinafter, when video information and sound information do not need to be distinguished from each other, the video information and sound information will be collectively referred to as analysis information.

The sound analysis unit 103 outputs the sound information obtained by analysis to the importance determination unit 105 and the pin detection unit 106 along with the sound signal.

The control parameter input unit 104 receives the rule signal indicating the importance determination rule, the rule signal indicating the pin detection rule, and the rule signal indicating the edit rule, the rules being supplied from the input/output device 4.

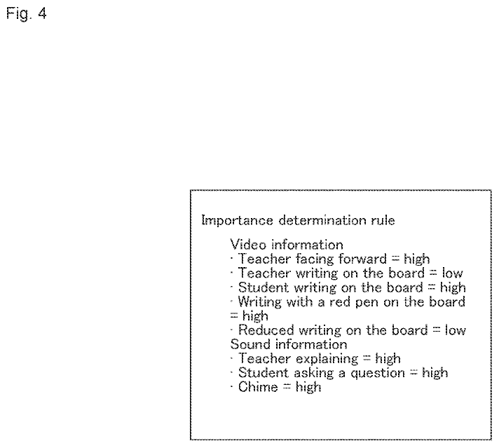

FIG. 4 shows an example of the importance determination rule.

As shown in FIG. 4, as the importance determination rule for video information, the user indicates, for example, rules including “highly important when a teacher faces forward (rearward in a classroom),” “highly important when a teacher writes on the board,” “highly important when a student writes on the board,” “highly important when a teacher or a student writes with a red pen on the board,” and “less important when an amount of writing on the board decreases.”

As the importance determination rule for sound information, the user indicates, for example, rules including “highly important when a teacher provides an explanation,” “highly important when a student asks a question,” and “highly important when a chime sounds.”

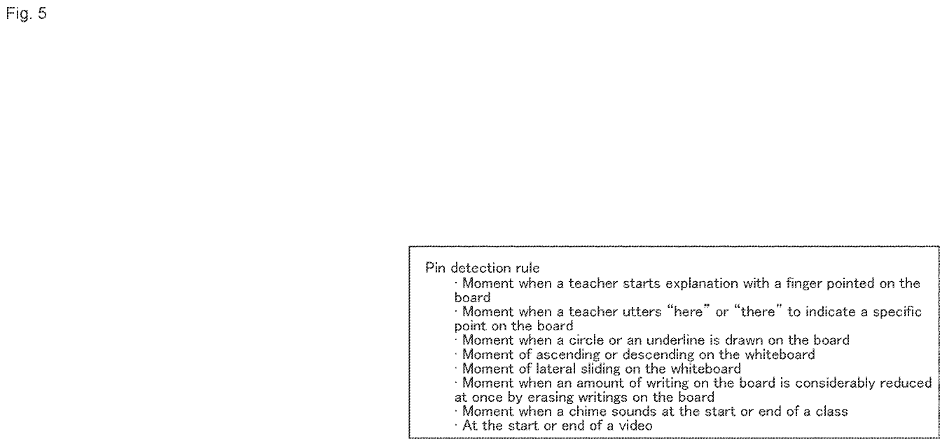

FIG. 5 shows an example of the pin detection rule.

As shown in FIG. 5, as the pin detection rule, the user indicates, for example, rules including “a moment when a teacher starts an explanation with a finger pointed at the board,” “a moment when a teacher utters “here” or “there” to indicate a specific point on the board,” “a moment when a circle or an underline is drawn on the board,” “a moment of ascending or descending on the whiteboard,” “a moment of lateral sliding on the whiteboard,” “a moment when an amount of writing on the board is considerably reduced at once by erasing writings on the board,” “a moment when a chime sounds at the start or end of a class,” and “at the start or end of a video.”

In the arithmetic unit 2, on the basis of the pin detection rule, sections including moments when a teacher performs an action to emphasize a part of writing on the board are detected as pins from among a plurality of sections obtained by dividing recorded data. For example, “a moment when a teacher starts an explanation with a finger pointed on the board,” “a moment when a teacher utters “here” or “there” to indicate a specific point on the board,” and “a moment when a circle or an underline is drawn on the board,” are detected as pins. Furthermore, sections including moments when the scenes or contents of a lecture are changed are detected as pins. For example, “a moment of ascending or descending on the whiteboard,” “a moment of lateral sliding on the whiteboard,” “a moment when an amount of writing on the board is considerably reduced at once by erasing writings on the board,” “a moment when a chime sounds at the start or end of a class,” and “at the start or end of a video” are detected as pins.

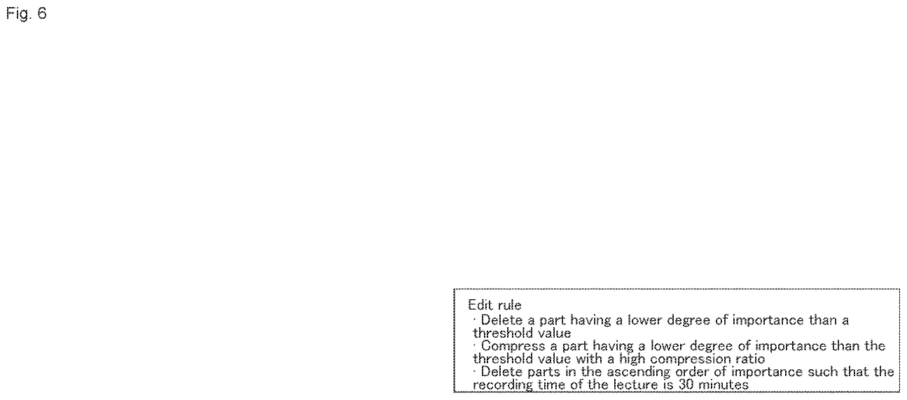

FIG. 6 shows an example of the edit rule.

As shown in FIG. 6, as the edit rule, the user indicates rules including “delete a part having a lower degree of importance than a threshold value,” “compress a part having a lower degree of importance than the threshold value with a high compression ratio,” and “delete parts in the ascending order of importance such that the recording time of the lecture is 30 minutes.”

The control parameter input unit 104 in FIG. 3 outputs the rule signal indicating the importance determination rule to the importance determination unit 105 and outputs the rule signal indicating the pin detection rule to the pin detection unit 106. Moreover, the control parameter input unit 104 outputs the rule signal indicating the edit rule to the automatic editing unit 107.

According to the rule signal supplied from the control parameter input unit 104, the importance determination unit 105 determines the degree of importance of the video signal on the basis of the video information and determines the degree of importance of the sound signal on the basis of the sound information.

The importance determination unit 105 divides the recorded data into short time periods and determines the degree of importance for each of the video signal and the sound signal that are included in a separated section, instead of determining the degree of importance of a unique value entirely for the video signal and the sound signal. The degree of importance of the video signal and the degree of importance of the sound signal are determined in each section.

Various methods may be used as a method of dividing the recorded data. For example, the methods include a method of dividing the recorded data at predetermined time intervals (e.g., five seconds), a method of dividing the recorded data on the basis of a teacher's voice (e.g., a sound pressure), a method of recognizing the tip of a pen used for writing on the board and dividing the recorded data when the tip of the pen is separated from the board surface of a white board for a predetermined time, and a method of dividing the recorded data on the basis of an increase/decrease in the number of characters on the board. These dividing methods may be combined to divide the recorded data.

The importance determination unit 105 determines the degree of importance of the video signal and the degree of importance of the sound signal in each of the sections obtained by dividing the recorded data, as a value of, for example, −1.0 to 1.0 instead of a binary value of important or unimportant.

Furthermore, the degree of importance of the video signal and the degree of importance of the sound signal may be determined for a determination section that is a combination of successive sections. In this case, the degree of importance of the video signal and the degree of importance of the sound signal in the determination section are each supposed to be a mean value, a maximum value, or a minimum value of the degree of importance of the video signal and the degree of importance of the sound signal in each of the sections included in the determination section, or a weighted sum corresponding to a time length of each section.

If the degree of importance is determined on the basis of kinds of analysis information, a final degree of importance is supposed to be one of a mean value, a maximum value, a minimum value, the sum, and the product of degrees of importance determined on the basis of each kind of analysis information, and a weighted sum corresponding to a weight indicated by the rule signal.

The number of sections combined as the determination section is, for example, a predetermined number. A predetermined number of sections based on a teacher's voice, a predetermined number of sections based on the recognition result of the tip of a pen, or a predetermined number of sections based on an increase/decrease in the number of characters on the board may be combined as a determination section.

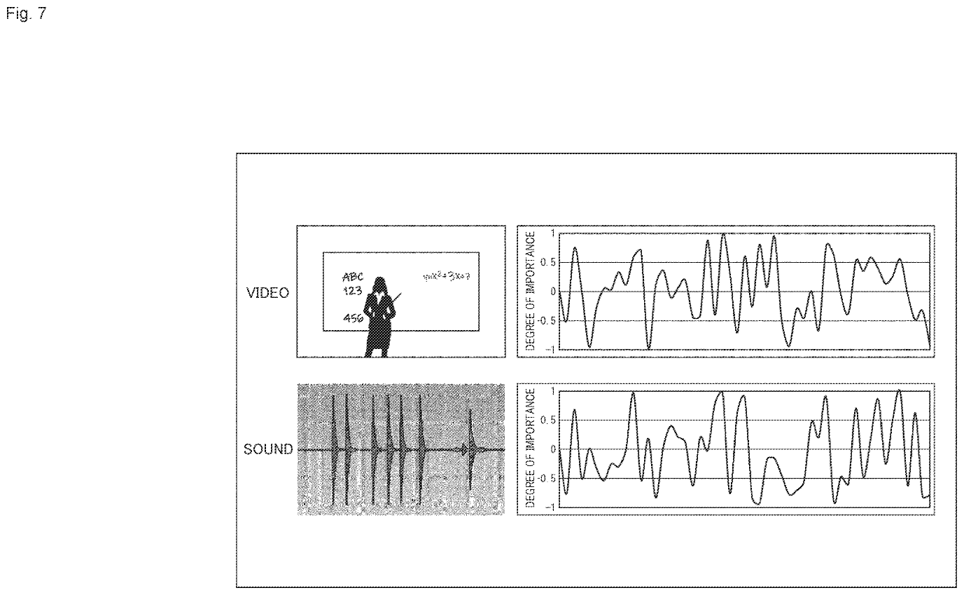

FIG. 7 shows an example of the degree of importance.

The upper side of FIG. 7 shows a waveform indicating the degree of importance of the video signal. The horizontal axis represents a determination section and the vertical axis represents a degree of importance.

A value based on video information analyzed for the video signal of each determination section by the video analysis unit 102 is determined as the degree of importance of the video signal of each determination section.

The lower side of FIG. 7 shows a waveform indicating the degree of importance of the sound signal. The horizontal axis represents a determination section and the vertical axis represents a degree of importance.

A value based on sound information analyzed for the video signal of each determination section by the sound analysis unit 103 is determined as the degree of importance of the sound signal of each determination section.

As described above, in the importance determination unit 105, the degree of importance of the video signal and the degree of importance of the sound signal are separately determined.

Returning to FIG. 3, the importance determination unit 105 outputs the determination result of the degree of importance to the automatic editing unit 107 along with the video signal supplied from the video analysis unit 102 and the sound signal supplied from the sound analysis unit 103.

According to the pin detection rule supplied from the control parameter input unit 104, the pin detection unit 106 detects a pin on the basis of the video information and the sound information.

As in the determination of the degree of importance, a pin is detected for each of the sections obtained by dividing the recorded data into short time periods. In addition, a section recognition unit for dividing the recorded data for each section may be provided upstream of the importance determination unit 105 and the pin detection unit 106.

The pin detection unit 106 detects, as a pin, a section including the video signal or the sound signal at a moment indicated by the pin detection rule. Successive sections detected as pins may be combined to be detected as a pin.

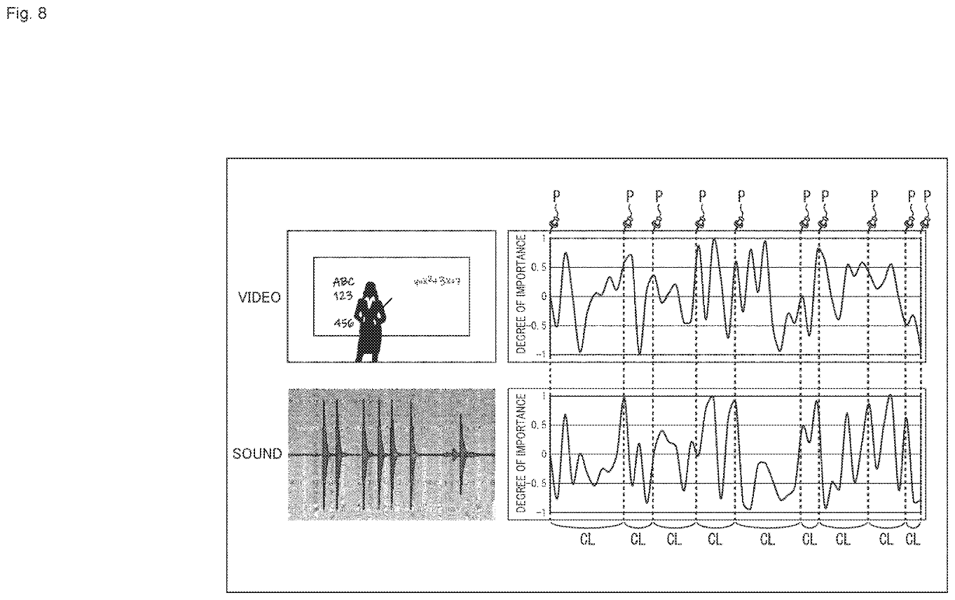

FIG. 8 shows an example of the pin.

As shown in FIG. 8, a plurality of pins P for dividing the recorded data including the video signal and the sound signal are detected. Recorded data between a predetermined pin P and other consecutive pins P serves as a clip CL.

The result of pin detection by the pin detection unit 106 is outputted to the automatic editing unit 107.

According to the rule signal supplied from the control parameter input unit 104, the automatic editing unit 107 edits the recorded data on the basis of the result of importance determination by the importance determination unit 105 and the result of pin detection by the pin detection unit 106.

Specifically, for each clip, the automatic editing unit 107 edits the video signal according to the degree of importance of the video signal and edits the sound signal according to the degree of importance of the sound signal. For example, editing is performed for each clip such that among video signals in sections constituting a clip, the video signals in a predetermined number of sections are deleted from the video signals in sections having the lowest degree of importance, and among sound signals in sections constituting a clip, the sound signals in a predetermined number of sections are deleted from the sound signals in sections having the lowest degree of importance. The video signals and sound signals are deleted such that the video signals and the sound signals that are included in a clip have an equal time period.

In this way, the recorded data is edited in consideration of each clip such that the video signal and the sound signal are separately edited in each of the sections constituting a target clip.

If the recorded data is edited such that from a plurality of sections obtained by dividing the recorded data, sections having a low degree of importance are deleted while the video signal and the sound signal are synchronized with each other, some sections where one of the video signal and the sound signal is not important in learning may be left unerased.

In the present technique, the video signal and the sound signal that are not important in learning are deleted by separately editing the video signal and the sound signal, thereby generating a shorter lecture video than in editing with the video signal and the sound signal synchronized with each other.

Thus, a lecture video can be generated to enable efficient learning, for example, learning by a student through viewing of a short video. Moreover, a lecture video can be generated to enable efficient recording, for example, recording of data that has been edited in a short time.

Editing is performed such that the video signals and the sound signals in a clip are deleted by the same time period, so that the video signal and the sound signal in a section detected as a pin are reproduced in synchronization with each other in an edited lecture video. Thus, a lecture video can be generated such that the video signal and the sound signal are reproduced without being shifted from each other at a time when the contents of the video signal and the contents of the sound signal are to agree with each other, for example, when a teacher emphasizes a part of writing on the board.

Moreover, if the video signal and the sound signal in each section are separately compressed, a high-compression lecture video can be generated as compared with editing performed while the video signal and the sound signal are synchronized with each other. Thus, a lecture video can be generated to enable efficient recording.

Editing is performed such that the video signals and the sound signals in each clip are deleted by a time period with the same ratio. For example, it is assumed that a 30-minute clip A and a 60-minute clip B constitute the recorded data. If the 90-minute recorded data is edited to recorded data of a half time period, that is, 45 minutes, the video signals and the sound signals are deleted to reduce the time of each clip to a half.

Editing may be performed such that the video signals and the sound signals in each clip are deleted by a time period corresponding to the distribution of the degrees of importance of the overall recorded data. For example, the time of an edited clip is determined according to the degree of importance of the overall clip.

It is assumed that the clip A always has a relatively high degree of importance and the clip B always has a relatively low degree of importance in the recorded data including the clip A and the clip B as described above. When the 90-minute recorded data is edited to 45-minute recorded data, for example, the video signals and the sound signals in the clip A are outputted without being deleted, whereas the video signals and the sound signals in the clip B are outputted after being deleted to have a time period of 15 minutes. The ratio of the time of a clip after an edit and the time of the clip before the edit may be changed from a constant ratio of 1 to 2 to any ratio according to the degree of importance of the clip. For example, the video signals and the sound signals in the clip A may be deleted to have a 2:3 ratio (20 minutes) and the video signals and the sound signals in the clip B may be deleted to have a 5:12 ratio (25 minutes). Time periods for the video signals and the sound signals to be deleted from each clip may be indicated by a user through the input/output device 4.

Recorded data that is edited by the automatic editing unit 107 and includes the video signals and the sound signals is outputted to the video output unit 108.

The video output unit 108 outputs the recorded data that is supplied from the automatic editing unit 107, to the recording device 3 and the input/output device 4.

### <2. Example of Edit to Recorded Data>

An example of an edit to the recorded data that is obtained by recording a lecture in a classroom illustrated with reference to FIG. 1 will be described below. It is assumed that a lecture of 120 minutes was provided in the classroom of FIG. 1.

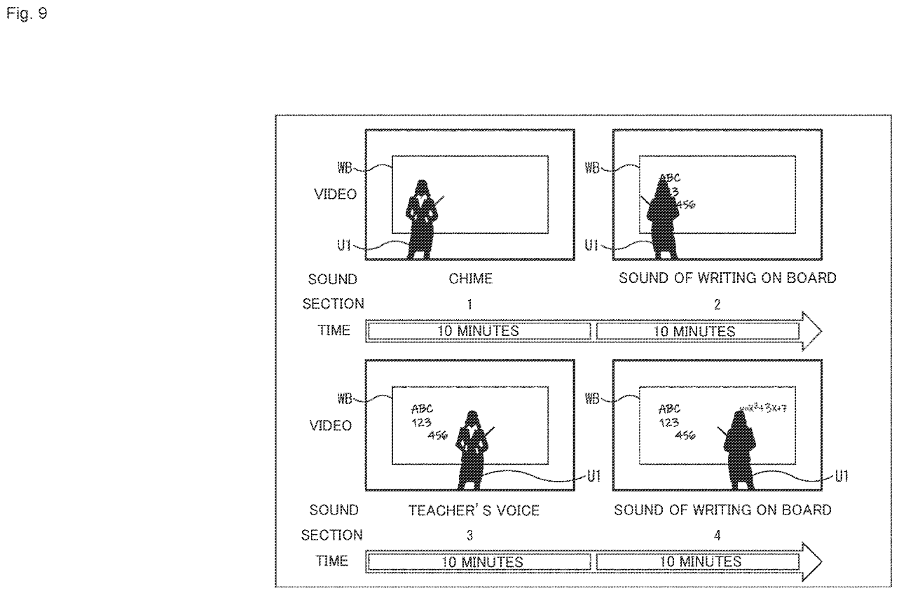

FIGS. 9 to 11 illustrate an example of a timeline of a lecture video.

In FIGS. 9 to 11, the recorded data on a lecture video is divided into 12 determination sections 1 to 12 in chronological order. The determination sections are 10-minute sections. FIGS. 9 to 11 show a typical screen shot and the contents of sound for each of the determination sections.

As shown in the upper left part of FIG. 9, the video signal of the determination section 1 indicates the teacher U1 standing in front of the whiteboard WB. Writing is not performed on the whiteboard WB. In the sound signal of the determination section 1, the sound of a chime is recorded.

As shown in the upper right part of FIG. 9, the video signal of the determination section 2 indicates the teacher U1 writing with a black pen on the left side of the whiteboard WB. In the sound signal of the determination section 2, the sound of writing on the board is recorded.

As shown in the lower left part of FIG. 9, the video signal of the determination section 3 indicates the teacher U1 explaining writing on the whiteboard WB. In the sound signal of the determination section 3, the voice of the teacher U1 is recorded.

As shown in the lower right part of FIG. 9, the video signal of the determination section 4 indicates the teacher U1 writing with a red pen on the upper right side of the whiteboard WB. In the sound signal of the determination section 4, the sound of writing on the board is recorded.

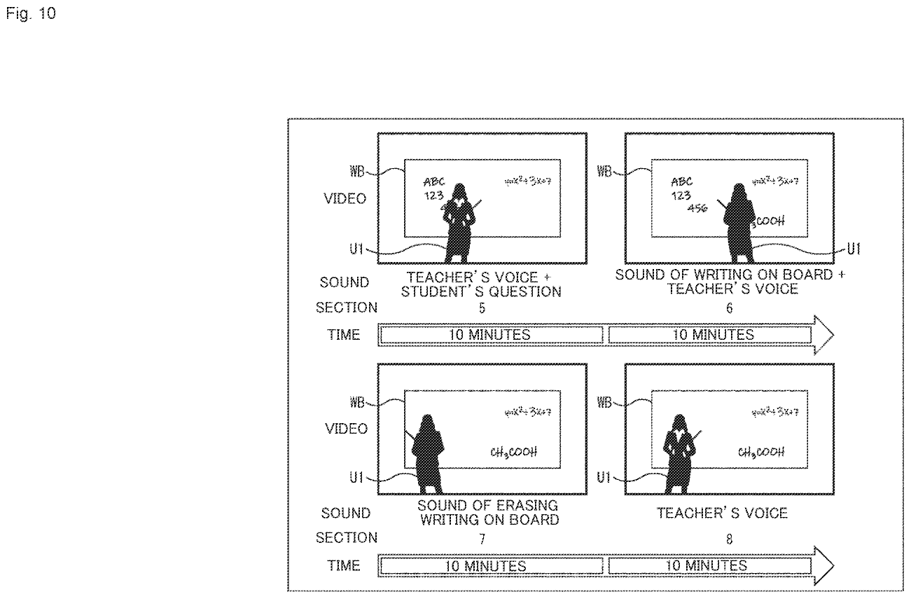

As shown in the upper left part of FIG. 10, the video signal of the determination section 5 indicates the teacher U1 explaining in response to a question from the student U2. In the sound signal of the determination section 5, the voice of the teacher U1 and the voice of the question from the student U2 are recorded.

As shown in the upper right part of FIG. 10, the video signal of the determination section 6 indicates the teacher U1 explaining while writing with a black pen on the lower right side of the whiteboard WB. A chemical formula is written on the whiteboard WB by the teacher U1. In the sound signal of the determination section 6, the sound of writing on the board and the voice of the teacher U1 are recorded.

As shown in the lower left part of FIG. 10, the video signal of the determination section 7 indicates the teacher U1 erasing writing on the left side of the whiteboard WB. In the sound signal of the determination section 7, the sound of erasing writing on the board is recorded.

As shown in the lower right part of FIG. 10, the video signal of the determination section 8 indicates the teacher U1 explaining a lecture. In the sound signal of the determination section 8, the voice of the teacher U1 is recorded.

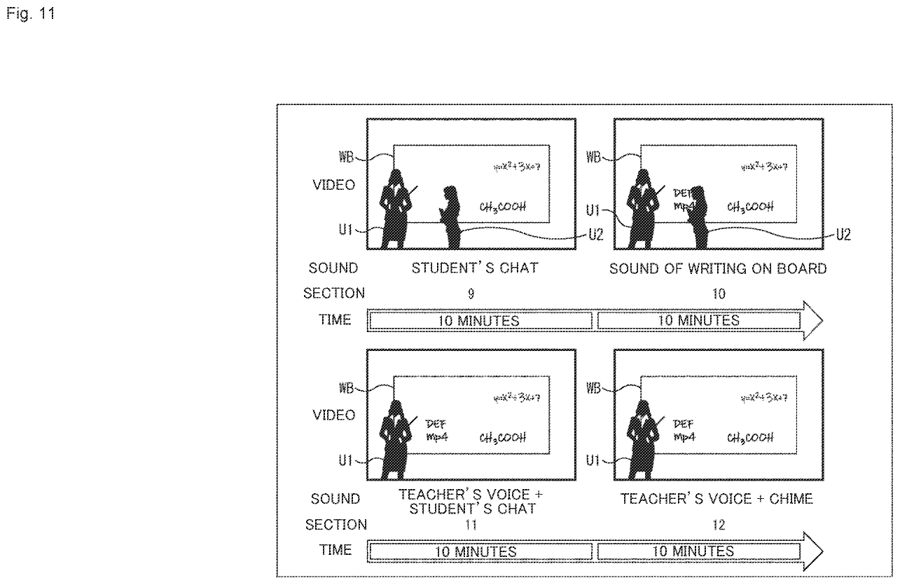

As shown in the upper left part of FIG. 11, the video signal of the determination section 9 indicates the chatting student U2 with the teacher U1 and the whiteboard WB. In the sound signal of the determination section 9, the voice of the chatting student U2 is recorded.

As shown in the upper right part of FIG. 11, the video signal of the determination section 10 indicates the student U2 writing with a black pen on the lower left side of the whiteboard WB. In the sound signal of the determination section 10, the sound of writing on the board is recorded.

As shown in the lower left part of FIG. 11, the video signal of the determination section 11 indicates the teacher U1 explaining writing by the student U2 on the whiteboard WB. In the sound signal of the determination section 11, the voices of chats of the teacher U1 and the student U2 are recorded.

As shown in the lower right part of FIG. 11, the video signal of the determination section 12 indicates the teacher U1 explaining a summary of the lecture. In the sound signal of the determination section 12, the voice of the teacher U1 and the sound of a chime are recorded.

The video analysis unit 102 analyzes video information for each of the video signals of the 12 determination sections. In this case, analyzed as video information includes the actions of the teacher, the direction of a teacher's face, the actions of the student, the color of writing on the board, an increase/decrease in the amount of writing on the board, and the contents of writing on the board.

The sound analysis unit 103 analyzes sound information for each of the sound signals of the 12 determination sections. In this case, analyzed as sound information includes the contents of a teacher's voice, a volume of a teacher's voice, a tone of a teacher's voice, a question of a student's voice, a chat of a student's voice, a chime, a sound of contents, and a sound of writing on the board.

The video information and the sound information are analyzed by using conventional methods. For example, a teacher and a student can be distinguished from each other by image-based personal identification or voiceprint-based personal identification or the contents of writing on the board can be recognized by combining a writing extracting function and an OCR (Optical Character Recognition).

The importance determination unit 105 determines the degree of importance of the video signal in each of the 12 determination sections on the basis of the video information and determines the degree of importance of the sound signal in each of the 12 determination sections on the basis of the sound information.

Specifically, the importance determination unit 105 determines the degree of importance of analysis information in each section according to the importance determination rule. For example, the recorded data is divided into sections at 5-second intervals. Thereafter, the importance determination unit 105 integrates 120 consecutive sections (10-minute section) into a single determination section and determines the mean value of the degrees of importance of analysis information in the 120 sections as the degree of importance of the single determination section.

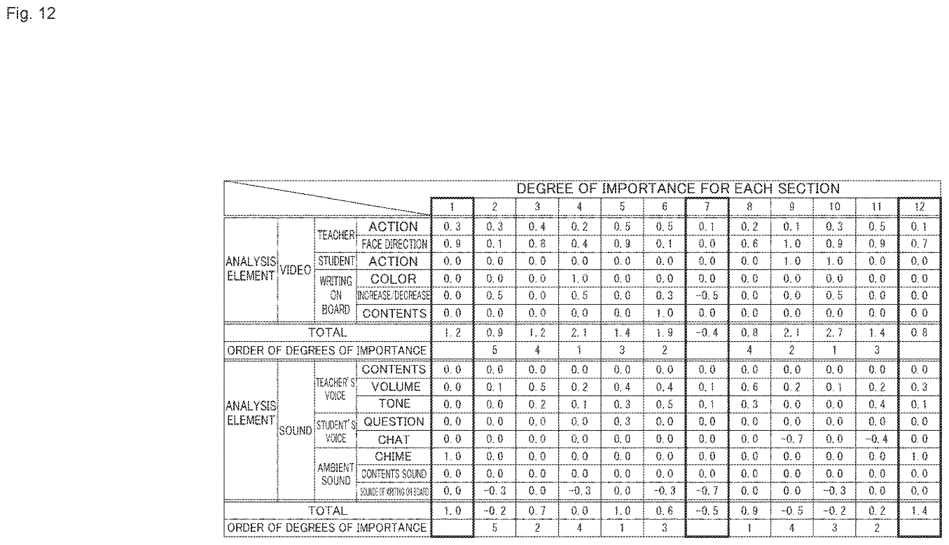

FIG. 12 shows an example of the degrees of importance of determination sections for the analysis information.

As shown in FIG. 12, as the degrees of importance of the video signals in the determination sections, the degrees of importance are determined for the actions of the teacher, the direction of a teacher's face, the actions of the student, the color of writing on the board, an increase/decrease in writing on the board, and the contents of writing on the board. Moreover, as the degrees of importance of the sound signals in the determination sections, the degrees of importance are determined for the contents of a teacher's voice, a volume of a teacher's voice, a tone of a teacher's voice, a question of a student's voice, a chat of a student's voice, a chime, a sound of contents, and a sound of writing on the board.

For example, in the determination section 1, it is determined that the degree of importance is 0.3 for the actions of the teacher, the degree of importance is 0.9 for the direction of a teacher's face, the degree of importance is 0 for the actions of the student, the degree of importance is 0 for the color of writing on the board, the degree of importance is 0 for an increase/decrease in writing on the board, and the degree of importance is 0 for the contents of writing on the board, the degree of importance is 0 for the contents of a teacher's voice, the degree of importance is 0 for a volume of a teacher's voice, the degree of importance is 0 for a tone of a teacher's voice, the degree of importance is 0 for a question of a student's voice, the degree of importance is 0 for a chat of a student's voice, the degree of importance is 1.0 for a chime, the degree of importance is 0 for a sound of contents, and the degree of importance is 0 for a sound of writing on the board.

Also for the determination sections 2 to 12, the degrees of importance are determined.

The importance determination unit 105 calculates the sum of the degrees of importance determined for the video information, as a final degree of importance of the video signal in each determination section, and calculates the sum of the degrees of importance determined for the sound information, as a final degree of importance of the sound signal in each determination section.

In the case of the example in FIG. 12, the final degrees of importance of the video signal in the determination sections 1 to 12 are determined as 1.2, 0.9, 1.2, 2.1, 1.4, 1.9, −0.4, 0.8, 2.1, 2.7, 1.4, and 0.8, respectively. Furthermore, the final degrees of importance of the sound signal in the determination sections 1 to 12 are determined as 1.0, −0.2, 0.7, 0.0, 1.0, 0.6, −0.5, 0.9, −0.5, −0.2, 0.2, and 1.4, respectively.

The pin detection unit 106 detects pins from the determination sections 1 to 12 on the basis of the analysis information. For example, the determination section 1, the determination section 7, and the determination section 12, which are surrounded by thick lines in FIG. 12, are detected as pins.

On the basis of the determination section 1, the determination section 7, and the determination section 12 as pins, the recorded data is divided into a clip A, in which the determination section 2 serves as a starting position and the determination section 6 serves as an end position, and a clip B, in which the determination section 8 serves as a starting position and the determination section 11 serves as an end position.

In the clip A, the order of the final degrees of importance for the video signal and the sound signal in the determination sections 2 to 6 is determined. The order of the final degrees of importance for the video signal of the clip A is determined such that the determination section 4 is in the first place, the determination section 6 is in the second place, the determination section 5 is in the third place, the determination section 3 is in the fourth place, and the determination section 2 is in the fifth place. The order of the final degrees of importance for the sound signal of the clip A is determined such that the determination section 5 is in the first place, the determination section 3 is in the second place, the determination section 6 is in the third place, the determination section 4 is in the fourth place, and the determination section 2 is in the fifth place.

In the clip B, the order of the final degrees of importance for the video signal and the sound signal in the determination sections 8 to 11 is determined except for the determination section 7 and the determination section 12 that are detected as pins.

The order of the final degrees of importance for the video signal of the clip B is determined such that the determination section 10 is in the first place, the determination section 9 is in the second place, the determination section 11 is in the third place, and the determination section 8 is in the fourth place. The order of the final degrees of importance for the sound signal of the clip B is determined such that the determination section 4 is in the first place, the determination section 11 is in the second place, the determination section 10 is in the third place, and the determination section 9 is in the fourth place.

In compliance with the edit rule, the automatic editing unit 107 separately edits the video signals and the sound signals for each clip according to the final degrees of importance of the video signals and the sound signals in the determination sections 1 to 12. In this case, as the edit rule, a rule is indicated such that “a deletion is made in the ascending order of the degrees of importance to reduce the time of a lecture video to two thirds of an actual lecture time.”

In this case, if the degrees of importance are determined as shown in FIG. 12, the automatic editing unit 107 performs an edit to delete, for example, the video signals of the determination section 2 and the determination section 3 in the ascending order of the degrees of importance from among the video signals of the determination sections 2 to 6 constituting the clip A.

Moreover, the automatic editing unit 107 performs an edit to delete the sound signals of the determination section 2 and the determination section 4 in the ascending order of the degrees of importance from among the sound signals of the determination sections 2 to 6 constituting the clip A.

Meanwhile, the automatic editing unit 107 performs an edit to delete the video signals of the determination section 8 and the determination section 11 in the ascending order of the degrees of importance from among the video signals of the determination sections 8 to 11 constituting the clip B.

Furthermore, the automatic editing unit 107 performs an edit to delete the sound signals of the determination section 9 and the determination section 10 in the ascending order of the degrees of importance from among the sound signals of the determination sections 8 to 11 constituting the clip B.

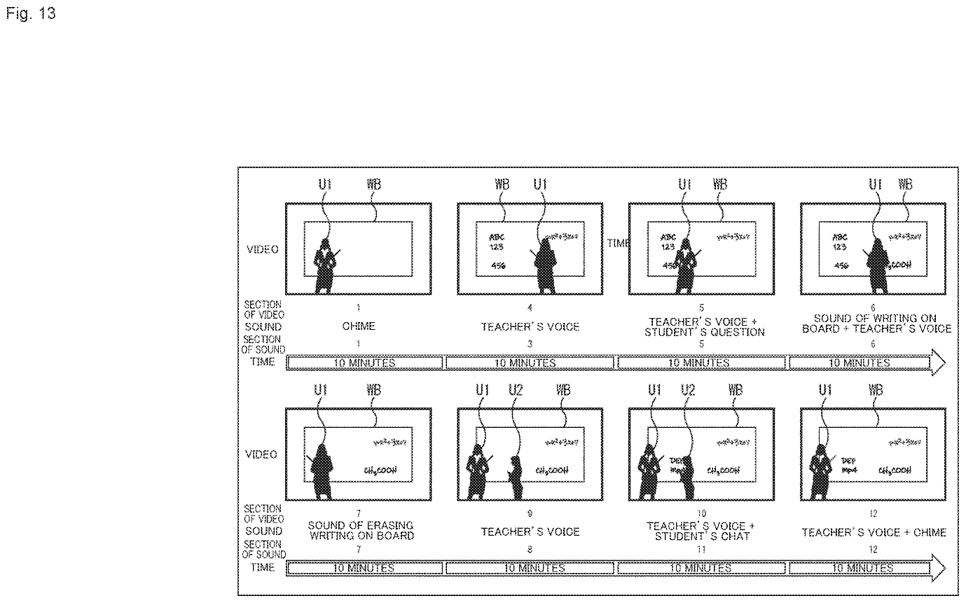

FIG. 13 illustrates an example of a timeline of the recorded data after the edit.

As shown in FIG. 13, the video signal included in the recorded data after the edit is a composite signal of the video signals of the determination section 1, the determination section 4, the determination section 5, the determination section 6, the determination section 7, the determination section 9, the determination section 10, and the determination section 12. Moreover, the sound signal included in the recorded data after the edit is a composite signal of the determination section 1, the determination section 3, the determination section 5, the determination section 6, the determination section 7, the determination section 8, the determination section 11, and the determination section 12.

This proves that the automatic editing unit 107 generates recorded data of 80 minutes, which is two thirds of an actual lecture time of 120 minutes.

From the video signals and the sound signals of the determination sections in a clip except for the determination sections detected as pins, the signals are deleted by the same time period, so that the video signal and the sound signal are reproduced in synchronization with each other in the determination section 1, the determination section 7, and the determination section 12 that are detected as pins.

The recorded data obtained by the edit is outputted to the recording device 3 and the input/output device 4 from the video output unit 108. The recorded data obtained by the edit is recorded in the recording device 3 or is presented to a user through the input/output device 4.

### 3. Operation of Arithmetic Unit

The operations of the arithmetic unit 2 configured thus will be described below.

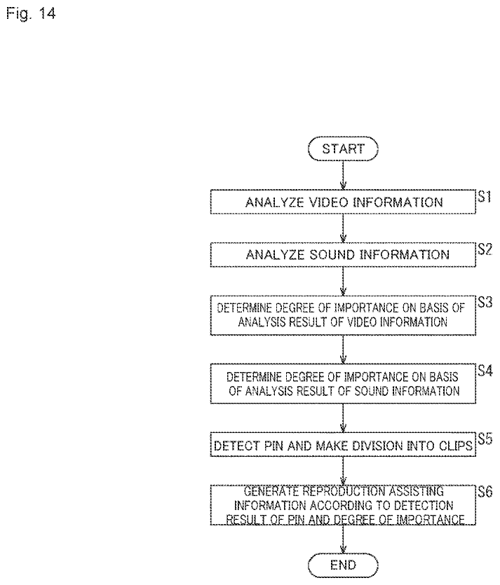

Referring to the flowchart of FIG. 14, processing performed by the arithmetic unit 2 will be described below.

The processing of FIG. 14 is started, for example, when the recorded data is inputted from the video shooting device 1 to the video input unit 101. From the recorded data, the video signal is outputted to the video analysis unit 102 while the sound signal is outputted to the sound analysis unit 103.

In step S1, the video analysis unit 102 analyzes the video information on the basis of the video signal.

In step S2, the sound analysis unit 103 analyzes the sound information on the basis of the sound signal. The processing of step S2 may be performed in parallel with the processing of step S1 or may be performed after the processing of step S1 is performed.

In step S3, the importance determination unit 105 determines the degree of importance of the video signal in each of the sections obtained by dividing the recorded data, on the basis of the result of analysis of the video information by the video analysis unit 102.

In step S4, the importance determination unit 105 determines the degree of importance of the sound signal in each of the sections obtained by dividing the recorded data, on the basis of the result of analysis of the sound information by the sound analysis unit 103.

In step S5, on the basis of the result of analysis of the video information by the video analysis unit 102 and the result of analysis of the sound information by the sound analysis unit 103, the pin detection unit 106 detects the sections serving as pins from the sections obtained by dividing the recorded data, and divides the recorded data into clips.

In step S6, the automatic editing unit 107 generates reproduction assisting information according to the result of detection of pins by the pin detection unit 106 and the result of determination of the degree of importance by the importance determination unit 105. In other words, the automatic editing unit 107 acts as a generation unit that generates reproduction assisting information. The reproduction assisting information is information used for providing a user with contents such as a lecture video. The automatic editing unit 107 generates recorded data as reproduction assisting information by performing an edit, for example, deleting the video signals and the sound signals from the sections having the lowest degree of importance or compressing the video signals and the sound signals with a high compression ratio from the sections having the lowest degree of importance.

Furthermore, meta information for editing for each clip according to the degree of importance and meta information for reproduction for each clip according to the degree of importance may be generated as reproduction assisting information. The meta information will be described later.

After the reproduction assisting information is generated, the processing of FIG. 14 ends. The reproduction assisting information is outputted to the recording device 3 or the input/output device 4 by the video output unit 108 and is used for providing the user with a lecture video. For example, the input/output device 4 displays a lecture video obtained by reproducing the recorded data serving as the reproduction assisting information and presents the lecture video to the user.

As described above, in the present technique, the degree of importance of the video signal and the degree of importance of the sound signal in each of the sections obtained by dividing the recorded data are determined on the basis of the analysis information about the lecture. The video signal is edited according to the degree of importance of the video signal in each of the sections, and the sound signal is edited according to the degree of importance of the sound signal in each of the sections.

The analysis information about the lecture includes information about the teacher and the student and information about writing on the board, a chime, materials attached to the whiteboard, and video materials.

Since the recorded data is edited according to the degree of importance of the analysis information about the lecture, the arithmetic unit 2 can edit the recorded data without missing important information in the recording of the lecture, for example, the order of writing on the board.

The user as a viewer of the lecture video views the video after insignificant sections for learning are deleted from the video. This allows the user to learn the contents of the lecture in a shorter time than an actual lecture time.

In the present technique, the video signal and the sound signal that are not important in learning are deleted by separately editing the video signal and the sound signal, thereby generating a shorter lecture video than in editing with the video signal and the sound signal synchronized with each other.

If the video signal and the sound signal are separately edited according to the degree of importance without detecting pins, a disparity between the contents of the video signal and the contents of the sound signal may increase at the midpoint or the endpoint of the recorded data after the edit.

In the present technique, editing is performed such that the video signal and the sound signal in a section detected as a pin are synchronized with each other. This enables an edit to reproduce the video signal and the sound signal in synchronization with each other at a moment when synchronization between the contents of the video signal and the contents of the sound signal is important, for example, a moment when a teacher pointed a part of writing on the board.

### 4. Modification Example

### Analysis Information About Lecture

In the foregoing example, pins are detected and the degree of importance is determined on the basis of the analysis information about writing on the whiteboard. Pins may be detected and the degree of importance may be determined on the basis of analysis information about a screen where presentation materials are projected.

In this case, for example, pins are detected or the degree of importance is determined on the basis of analysis information about switching of slides and animation. In this way, the present technique is also applicable to shooting of a lecture in which means other than writing on the board is used. Alternatively, a lecture may be video-shot while a whiteboard and a screen are simultaneously present in the angle of view of the video shooting device 1.

Pins may be detected and the degree of importance may be determined on the basis of analysis information about writing on a blackboard, a green board, or simili paper instead of the whiteboard.

The sound of a lecture may be collected by a sound pickup device different from that installed in the video shooting device 1. For example, a voice of a teacher can be collected by a clip-on microphone of the teacher. In this case, the clip-on microphone is connected to the arithmetic unit 2 and outputs a sound signal indicating the collected sound to the arithmetic unit 2.

The kind of analysis information to be analyzed by the video analysis unit 102 and the sound analysis unit 103 can be set in advance or can be indicated from a user by a rule signal inputted through the input/output device 4. For example, if the user assigns high priority to a real-time operation, an instruction to analyze necessary and sufficient analysis information is provided.

Reproduction Assisting Information Meta information for editing for each clip according to the degree of importance may be generated as reproduction assisting information by the automatic editing unit 107. For example, meta information about the result of importance determination by the importance determination unit 105 and the result of pin detection by the pin detection unit 106 is generated by the automatic editing unit 107 as meta information for editing for each clip according to the degree of importance.

In this case, the video output unit 108 outputs the recorded data that is supplied from the video shooting device 1 and the meta information that is generated by the automatic editing unit 107, to the recording device 3 and the input/output device 4.

For example, if a plurality of users need to view a lecture video for different time periods according to the skill levels, the input/output device 4 edits the recorded data for each of the users by using the meta information supplied from the arithmetic unit 2 and reproduces the recorded data after the edit. Thus, the video shooting device 1 can provide a lecture video with a time period corresponding to the skill of each user.

The recorded data may be edited by the arithmetic unit 2 according to the skill of each user such that the recorded data is edited on the basis of the meta information recorded in the recording device 3 and according to a rule signal indicating an edit rule for performing an edit according to the skill of each user.

Moreover, meta information for reproduction according to the degree of importance and the starting position of a clip may be generated as reproduction assisting information by the automatic editing unit 107. For example, meta information about the result of importance determination by the importance determination unit 105 and the result of pin detection by the pin detection unit 106 is generated by the automatic editing unit 107 as meta information for reproduction according to the degree of importance and the starting position of a clip.

In this case, the video output unit 108 outputs the recorded data that is supplied from the video shooting device 1 and the meta information that is generated by the automatic editing unit 107, to the recording device 3 and the input/output device 4.

The input/output device 4 displays, for example, the reproduction position of a section having a high degree of importance and the starting position of a clip (the reproduction position of a pin) on the seek bar of the viewing screen of the lecture video. Thus, the user as a viewer of the lecture video can select, for example, a reproduction position displayed on the seek bar of the viewing screen and easily reproduce, from the lecture video, the video of an important section or a video at a moment when the scenes of the lecture are changed during learning.

Furthermore, along with the reproduction assisting information, thumbnail images indicating the sections with determined degrees of importance may be generated by the automatic editing unit 107.

For example, the arithmetic unit 2 determines the degrees of importance of frames constituting a section and sets the frame image of the frame with the highest degree of importance as a thumbnail image. The frame image of the first or last frame of each section may be set as a thumbnail image.

The video output unit 108 outputs the reproduction assisting information generated by the automatic editing unit 107 and the thumbnail images of each section of the lecture video to the recording device 3 and the input/output device 4.

If the thumbnail images are supplied to the input/output device 4 along with the meta information for reproduction according to the degree of importance and the starting position of a clip, the input/output device 4 displays the reproduction position of a section having a high degree of importance or the starting position of a clip and the thumbnail images of the section having the high degree of importance or pins, on the seek bar of the viewing screen. Thus, the input/output device 4 can present more accurate information to the user viewing the lecture video.

### Pin Detection Method

In addition to the detection of pins on the basis of the video information and the sound information, pins may be detected on the basis of a rule signal obtained by the control parameter input unit 104 or the like. The rule signal indicates the timing for setting a pin.

For example, a teacher can indicate the timing for switching the contents of a lecture by operating the input/output device 4 or the like in the lecture. In this case, a section including the timing indicated by the user is detected as a pin.

If meta information for editing for each clip according to the degree of importance is recorded in the recording device 6 along with the recorded data, the user of the input/output device 4 can indicate any timing during an edit by the input/output device 4. In this case, a section including the timing indicated by the user is detected as a pin.

If two or more video signals are included in the recorded data, only when a moment to be detected as a pin is included in both of the video signals, the section including the moment may be detected as a pin. Likewise, if two or more sound signals are included in the recorded data, only when a moment to be detected as a pin is included in both of the sound signals, the section including the moment may be detected as a pin. The pin detection method is expressed by the rule signal acquired by the control parameter input unit 104.

### Application Example

The present technique is also applicable to, for example, an edit to a sports video or an e-sports video (game video) as well as an edit to a lecture video.

Recorded data on a sports video includes three signals, for example, a video signal indicating a sports scene, a sound signal indicating a sports scene, and a sound signal of a commentary voice. In contents like a sports video where realism is required, the contents of a video signal indicating a sports scene and the contents of a sound signal indicating the sports scene need to agree with each other to obtain realism.

When recorded data on a sports video is edited, the determination of the degree of importance and the detection of pins are performed for all the three signals. The video signal indicating a sports scene and the sound signal indicating the sports scene are edited for each clip such that the video signal and the sound signal are always reproduced in synchronization with each other. The sound signal of a commentary voice is edited for each clip without being synchronized with the other two signals in sections other than sections detected as pins.

As described above, in the present technique, the video signal of a video of contents and the sound signal of a sound related to the contents are edited for each clip as edits to recorded data on contents such as a lecture video, a sports video, and an e-sports video.

The sound related to the contents includes, for example, a sound of the contents and a sound as a commentary on the contents. If the contents is a sports video, the video of the contents is a video indicating a sports scene and the sound of the contents is a sound indicating the sports scene. The sound as a commentary on the contents is a commentary voice.

### Editing Method

In the case of compression by the automatic editing unit 107 for each clip according to the degree of importance, the number of sections of the video signal and the number of sections of the sound signal may be different from each other in compression in the same clip.

In addition to editing according to the degree of importance, editing may be performed on the basis of other rule signals obtained by the control parameter input unit 104 or the like. For example, the user can instruct the arithmetic unit 2 to delete a predetermined section or the overall clip by operating the input/output device 4.

In the foregoing example, the recorded data is entirely divided into a plurality of sections. The video signal and the sound signal may be divided into a plurality of sections according to different methods. In this case, for example, pins are detected in a plurality of sections obtained by dividing the overall recorded data, and then the video signal and the sound signal that are included in a clip are divided into a plurality of sections according to different methods.

If two or more video signals are included in the recorded data, the video signals may be divided into a plurality of sections according to different methods. If two or more sound signals are included in the recorded data, the sound signals may be divided into a plurality of sections according to different methods. Also in this case, for example, pins are detected in a plurality of sections obtained by dividing the overall recorded data, and then the video signals and the sound signals that are included in a clip are divided into a plurality of sections according to different methods.

### Computer

The series of processing described above can be executed by hardware or software. When the series of processing is performed by software, a program for the software is embedded in dedicated hardware to be installed from a program recording medium to a computer or a general-purpose personal computer.

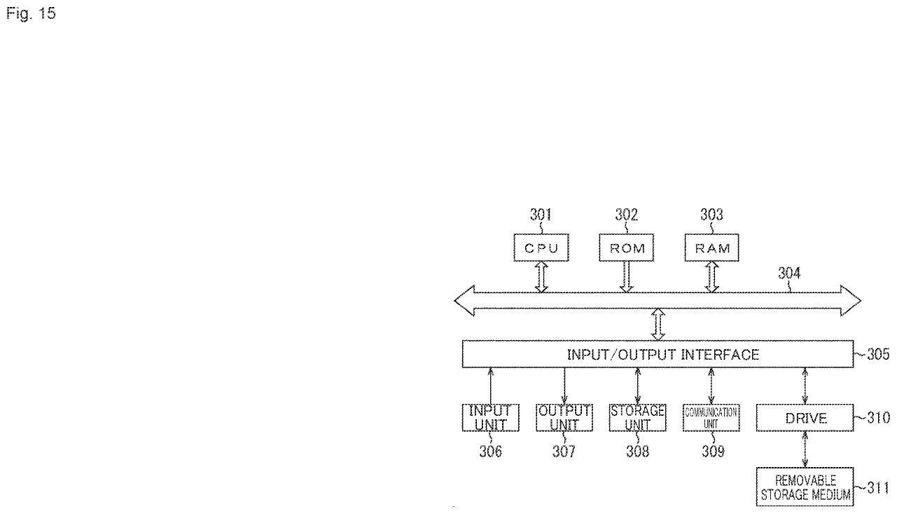

FIG. 15 is a block diagram illustrating a configuration example of computer hardware that executes the aforementioned series of processing using a program.

A CPU (Central Processing Unit) 301, a read-only memory (ROM) 302, and a random access memory (RAM) 303 are connected with one another by a bus 304.

An input/output interface 305 is further connected to the bus 304. An input unit 306 including a keyboard or a mouse and an output unit 307 including a display or a speaker are connected to the input/output interface 305. In addition, a storage unit 308 including a hard disk or a nonvolatile memory, a communication unit 309 including a network interface, a drive 310 driving a removable medium 311 are connected to the input/output interface 305.

In the computer configured as described above, for example, the CPU 301 loads a program stored in the storage unit 308 onto the RAM 303 via the input/output interface 305 and the bus 304 and executes the program to perform the series of processing steps described above.

For example, the program executed by the CPU 301 is recorded on the removable medium 311 or provided via a wired or wireless transfer medium such as a local area network, the Internet, or a digital broadcast to be installed in the storage unit 308.

Note that the program executed by a computer may be a program that performs processing chronologically in the order described in the present specification or may be a program that performs processing in parallel or at a necessary timing such as a called time.

Meanwhile, in the present specification, a system is a collection of a plurality of constituent elements (devices, modules (components), or the like) and all the constituent elements may be located or not located in the same casing. Thus, a plurality of devices housed in separate housings and connected via a network, and one device in which a plurality of modules are housed in one housing are both systems.

The effects described in the present specification are merely examples and are not intended as limiting, and other effects may be obtained.

The embodiments of the present technology are not limited to the aforementioned embodiments, and various changes can be made without departing from the gist of the present technology.

For example, the present technique may be configured as cloud computing in which a plurality of devices share and cooperatively process one function via a network.

In addition, each step described in the above flowchart can be executed by one device or executed in a shared manner by a plurality of devices.

Furthermore, in a case in which one step includes a plurality of processes, the plurality of processes included in the one step can be executed by one device or executed in a shared manner by a plurality of devices.

### <Combination Example of Configuration>

The present technique can be configured as follows.
(1)
An information processing device includes a generation unit configured to generate reproduction assisting information for reproducing a video of contents and a sound related to the contents, the video and sound included in a target clip among a plurality of clips obtained by dividing data including the video and the sound, the reproduction assisting information generated according to a first degree of importance that is a degree of importance of a plurality of sections obtained by further dividing the video included in the target clip and a second degree of importance that is a degree of importance of a plurality of sections obtained by further dividing the sound included in the target clip.
(2)
The information processing device according to (1), further including a detection unit that detects, as a pin from the data, a section where the timing for reproducing the video and the timing for reproducing the sound are synchronized with each other, and divides the data such that the data between the pin and another pin serves as the clip.
(3)
The information processing device according to (2), wherein the contents serve as a lecture video obtained by video-shooting a lecture, and the detection unit detects the pin on the basis of information about the lecture.
(4)
The information processing device according to (3), wherein the detection unit detects, as the pin, a section including a moment when a lecturer of the lecture emphasizes writing on the board or a moment when the contents of the lecture are changed.
(5)
The information processing device according to any one of (2) to (4), wherein the detection unit detects the pin according to a detection rule indicated by a user through an input device that receives a user operation.
(6)
The information processing device according to any one of (1) to (5), wherein the generation unit generates edited data as the reproduction assisting information by editing the video included in the target clip according to the first degree of importance and edits the sound included in the target clip according to the second degree of importance.
(7)
The information processing device according to (6), wherein the generation unit generates the edited data by performing deletion or compression from a section having the lowest first degree of importance from among a plurality of sections obtained by dividing the video included in the target clip and performing deletion or compression from a section having the lowest second degree of importance from among a plurality of sections obtained by dividing the sound included in the target clip.
(8)
The information processing device according to (7), wherein the generation unit deletes a video and a sound of the same time period from the video and the sound that are included in the target clip.
(9)
The information processing device according to (7) or (8), wherein the generation unit deletes a video and a sound of a time period corresponding to the degree of importance of the clip, from the video and the sound that are included in the clip.
(10)
The information processing device according to any one of (1) to (5), wherein the generation unit generates, as the reproduction assisting information, meta information for editing the video included in the target clip according to the first degree of importance and meta information for editing the sound included in the target clip according to the second degree of importance.
(11)
The information processing device according to any one of (1) to (5), wherein the generation unit generates, as the reproduction assisting information, meta information for reproducing the video and the sound according to at least one of the starting position of the clip, the first degree of importance, and the second degree of importance.
(12)
The information processing device according to any one of (1) to (11), wherein the generation unit generates the reproduction assisting information according to an edit rule indicated by a user through an input device that receives a user operation.
(13)
The information processing device according to (12), wherein the generation unit deletes a video and a sound of a time period indicated by the user, from the video and the sound that are included in the target clip.
(14)
The information processing device according to any one of (1) to (13), further including a determination unit that determines the first degree of importance of the sections obtained by dividing the video included in the target clip and determines the second degree of importance of the sections obtained by dividing the sound included in the target clip.
(15)
The information processing device according to (14), wherein the contents serve as a lecture video obtained by video-shooting a lecture, and
the determination unit determines the first degree of importance on the basis of information about the lecture, the information obtained by analyzing a video of the lecture, and determines the second degree of importance on the basis of information about the lecture, the information obtained by analyzing a sound of the lecture.
(16)
The information processing device according to (15), wherein the information about the lecture includes information about writing on the board by the lecturer of the lecture.
(17)
The information processing device according to any one of (14) to (16), wherein the determination unit determines the first degree of importance and the second degree of importance according to a determination rule indicated by a user through an input device that receives a user operation.
(18)
The information processing device according to any one of (1) to (17), wherein the sound related to the contents includes a sound of the contents and a sound as a commentary on the contents.
(19)
A generation method includes: generating reproduction assisting information for reproducing a video of contents and a sound related to the contents, the video and sound included in a target clip among a plurality of clips obtained by dividing data including the video and the sound, the reproduction assisting information generated according to a first degree of importance that is a degree of importance of a plurality of sections obtained by further dividing the video included in the target clip and a second degree of importance that is a degree of importance of a plurality of sections obtained by further dividing the sound included in the target clip.
(20)
A program for causing a computer to execute processing of
generating reproduction assisting information for reproducing a video of contents and a sound related to the contents, the video and sound included in a target clip among a plurality of clips obtained by dividing data including the video and the sound, the reproduction assisting information generated according to a first degree of importance that is a degree of importance of a plurality of sections obtained by further dividing the video included in the target clip and a second degree of importance that is a degree of importance of a plurality of sections obtained by further dividing the sound included in the target clip.

### REFERENCE SIGNS LIST

1 Video shooting device
2 Arithmetic unit
3 Recording device
4 Input/output device
101 Video input unit
102 Video analysis unit
103 Sound analysis unit
104 Control parameter input unit
105 Importance determination unit
106 Pin detection unit
107 Automatic editing unit
108 Video output unit

1. An information processing device comprising a generation unit configured to generate reproduction assisting information for reproducing a video of contents and a sound related to the contents, the video and sound included in a target clip among a plurality of clips obtained by dividing data including the video and the sound, the reproduction assisting information generated according to a first degree of importance that is a degree of importance of a plurality of sections obtained by further dividing the video included in the target clip and a second degree of importance that is a degree of importance of a plurality of sections obtained by further dividing the sound included in the target clip.

2. The information processing device according to claim 1, further comprising a detection unit that detects, as a pin from the data, a section where timing for reproducing the video and timing for reproducing the sound are synchronized with each other, and divides the data such that the data between the pin and another pin serves as the clip.

3. The information processing device according to claim 2, wherein the contents serve as a lecture video obtained by video-shooting a lecture, and
the detection unit detects the pin on a basis of information about the lecture.

4. The information processing device according to claim 3, wherein the detection unit detects, as the pin, a section including a moment when a lecturer of the lecture emphasizes writing on a board or a moment when the contents of the lecture are changed.

5. The information processing device according to claim 2, wherein the detection unit detects the pin according to a detection rule indicated by a user through an input device that receives a user operation.

6. The information processing device according to claim 1, wherein the generation unit generates edited data as the reproduction assisting information by editing the video included in the target clip according to the first degree of importance and edits the sound included in the target clip according to the second degree of importance.

7. The information processing device according to claim 6, wherein the generation unit generates the edited data by performing deletion or compression from a section having a lowest first degree of importance from among a plurality of sections obtained by dividing the video included in the target clip and performing deletion or compression from a section having a lowest second degree of importance from among a plurality of sections obtained by dividing the sound included in the target clip.

8. The information processing device according to claim 7, wherein the generation unit deletes a video and a sound of the same time period from the video and the sound that are included in the target clip.

9. The information processing device according to claim 7, wherein the generation unit deletes a video and a sound of a time period corresponding to a degree of importance of the clip, from the video and the sound that are included in the clip.

10. The information processing device according to claim 1, wherein the generation unit generates, as the reproduction assisting information, meta information for editing the video included in the target clip according to the first degree of importance and meta information for editing the sound included in the target clip according to the second degree of importance.

11. The information processing device according to claim 1, wherein the generation unit generates, as the reproduction assisting information, meta information for reproducing the video and the sound according to at least one of a starting position of the clip, the first degree of importance, and the second degree of importance.

12. The information processing device according to claim 1, wherein the generation unit generates the reproduction assisting information according to an edit rule indicated by a user through an input device that receives a user operation.

13. The information processing device according to claim 12, wherein the generation unit deletes a video and a sound of a time period indicated by the user, from the video and the sound that are included in the target clip.

14. The information processing device according to claim 1, further comprising a determination unit that determines the first degree of importance of the sections obtained by dividing the video included in the target clip and determines the second degree of importance of the sections obtained by dividing the sound included in the target clip.

15. The information processing device according to claim 14, wherein the contents serve as a lecture video obtained by video-shooting a lecture, and
the determination unit determines the first degree of importance on a basis of information about the lecture, the information obtained by analyzing a video of the lecture, and determines the second degree of importance on a basis of information about the lecture, the information obtained by analyzing a sound of the lecture.

16. The information processing device according to claim 15, wherein the information about the lecture includes information about writing on a board by a lecturer of the lecture.

17. The information processing device according to claim 14, wherein the determination unit determines the first degree of importance and the second degree of importance according to a determination rule indicated by a user through an input device that receives a user operation.

18. The information processing device according to claim 1, wherein the sound related to the contents includes a sound of the contents and a sound as a commentary on the contents.

19. A generation method comprising: generating reproduction assisting information for reproducing a video of contents and a sound related to the contents, the video and sound included in a target clip among a plurality of clips obtained by dividing data including the video and the sound, the reproduction assisting information generated according to a first degree of importance that is a degree of importance of a plurality of sections obtained by further dividing the video included in the target clip and a second degree of importance that is a degree of importance of a plurality of sections obtained by further dividing the sound included in the target clip.

20. A program for causing a computer to execute processing of
generating reproduction assisting information for reproducing a video of contents and a sound related to the contents, the video and sound included in a target clip among a plurality of clips obtained by dividing data including the video and the sound, the reproduction assisting information generated according to a first degree of importance that is a degree of importance of a plurality of sections obtained by further dividing the video included in the target clip and a second degree of importance that is a degree of importance of a plurality of sections obtained by further dividing the sound included in the target clip.
